(19) United States
(12) Patent Application Publication
(10) Pub. No.: US 2026/0184085 A1
(43) Pub. Date: Jul. 2, 2026

(54) PRINTING APPARATUS AND PRINTING METHOD

(71) Applicant: DOVER EUROPE SARL, Vernier (CH)

(72) Inventor: Samuel Achamfuo-Yeboah, Nottingham (GB)

(21) Appl. No.: 19/130,864

(22) PCT Filed: Nov. 8, 2023
(86) PCT No.: PCT/EP2023/081232

§ 371 Date: May 16, 2025

(30) Foreign Application Priority Data
Nov. 18, 2022 (GB) 2217319.9

(51) Int. Cl. B41J 2/325; B41J 11/00; B41J 13/00; B41J 33/00; B41J 33/14; G06F 3/12

(52) U.S. Cl. CPC B41J 2/325; B41J 11/008; B41J 13/0027; B41J 33/003; B41J 33/14; G06F 3/1219; G06F 3/1251

(57) ABSTRACT

A transfer printing apparatus and a method of printing, using a transfer printing apparatus including a ribbon, the method including using a length and a width of a first bounding area of an image to be printed, the length and the width of the first bounding area being associated with a first orientation of the image to be printed relative to the ribbon, to determine a length and a width of a second bounding area of the image to be printed, the second bounding area being associated with a second orientation of the image to be printed relative to the ribbon of the transfer printing apparatus.

### FIELD

The invention relates to a printing apparatus and a method of operation of a printing apparatus. In particular, the invention relates to a transfer printing apparatus and a method of operation of such a printing apparatus.

### BACKGROUND

Thermal transfer overprinting (TTO) technology is popular in product packaging and labelling. The printing apparatus is typically mounted inside a packaging machine, for example on a bracket.

Thermal transfer printing apparatuses are well known in the art. Typically, a thermal printing apparatus includes a pair of spools onto which tape (also known as ribbon) is wound. The ribbon is a long strip of material carrying ink, typically on one side. The ribbon extends between the spools (and usually passes around one or more guide members). A printhead is positioned on a side of the ribbon which does not carry ink, and moves to sandwich the ribbon between the printhead and a substrate, e.g. paper, film, labels, packaging materials, etc. Heating elements on the printhead are selectively heated to warm and soften portions of the ink on the ribbon, so as to enable transfer of ink from the ribbon to the substrate, in order to print an image and/or text, before the ribbon is peeled away from the substrate.

Such printing apparatus includes drive apparatus for moving the ribbon relative to the printhead, to present fresh ribbon, from which pixels of ink are yet to be removed, to the printhead, such that successive printing operations can be carried out. By enabling such movement and selectively energising the printing elements in each of a plurality of positions along the substrate and ribbon, a desired image may be built up from printed dots.

It is known to provide thermal transfer printing apparatus in two different configurations. In the first, so called “intermittent” configuration, the substrate to be printed and the ribbon are held stationary during a printing operation, whilst the printhead is moved across the area of the substrate to be printed. Once the printing operation is complete, the printhead is lifted away from the ribbon, and the ribbon is advanced to present a fresh region of ribbon to the printhead for the next printing operation. When used herein, in relation to the ribbon and/or substrate, “advance” may be understood to include movement of the ribbon in either direction.

In the second, so called “continuous” configuration, the substrate to be printed moves substantially continuously and the ribbon is accelerated to match the speed of the substrate before the printhead is brought into thermal contact with the ribbon and the printing operation is carried out by the printhead pressing the ribbon against the substrate. In this configuration, the printhead is maintained generally stationary during each printing operation.

The substrate is moved past the printhead in a substrate path. The ribbon moves past the printhead in a ribbon path, which adjacent the printhead is substantially parallel to the substrate path. Accurate relative positioning of the printhead, ribbon and substrate is important to ensure a high quality of print. Accurate control and timing of the movement of the printhead, ribbon and substrate is essential.

In some applications, it is desirable to print an image on the substrate at a specific angle to the direction of travel of the substrate. The current solution for such a requirement is to mount the printing apparatus such that the printhead and ribbon are positioned at the desired angle relative to the substrate. However, disadvantages of this are that non-standard brackets may be required; space constraints of a production line, for example, may mean that the printing apparatus cannot be accommodated at the desired angle; changing the ribbon and other maintenance procedures are more awkward and/or take longer; rotating the printing apparatus into and out of position may lead to alignment and/or set up issues; the platen which supports the substrate during a printing operation is substantially parallel to the substrate path, but the printhead no longer moves substantially parallel and/or in a direction substantially normal to the substrate path (this may lead to a shorter carriage run); this solution cannot work with a printer operating in continuous mode (which may be the most appropriate type of printer for the application).

It is important to minimise wasted ink, by ensuring that printing operations are carried out by removing portions of ink which are as close to one another on the ribbon as possible, without sacrificing print quality.

Embodiments of the present invention aim to provide an improved printing apparatus and/or method of operating a printing apparatus.

### BRIEF DESCRIPTION OF THE INVENTION

There is provided a method of printing, using a transfer printing apparatus including a ribbon, the method including using a length and width of a first bounding area of an image to be printed, the length and width of the first bounding area being associated with a first orientation of the image to be printed relative to the ribbon, to determine a length and width of a second bounding area of an image to be printed, the second bounding area being associated with a second orientation of the image to be printed relative to the ribbon of the transfer printing apparatus.

The method may include determining a print gap between the bounding areas of a first image and a second image each of the images being in its second orientation relative to the ribbon.

The method may include determining a distance through which the ribbon should be advanced between printing operations, when each of the images is in its second orientation.

The method may include one of
rendering the image and then rotating the image relative to the ribbon into its second orientation; and
rotating the image to be printed relative to the ribbon so that the image is in its second orientation and then rendering the image to printed.

The method may include printing an image in its second orientation relative to the ribbon.

The method may include printing successive images, each in a respective second orientation relative to the ribbon.

The method may include printing an image having a length that is greater than a width of the ribbon.

The method may include maintaining an aspect ratio of the image to be printed between the first orientation of the image and the second orientation of the image.

There is provided a transfer printing apparatus including a controller configured to carry out the method. The controller may include memory for storing commands and/or routines, to enable the method to be carried out.

The transfer printing apparatus may be a thermal transfer printing apparatus.

### BRIEF DESCRIPTION OF THE FIGURES

In order that the present disclosure may be more readily understood, preferable embodiments thereof will now be described, by way of example only, with reference to the accompanying drawings, in which:

FIG. 1 is an illustrative view of a printing apparatus;

FIG. 2 is an illustrative view of a ribbon, showing two images adjacent one another;

FIG. 3 is an illustrative view of a ribbon showing the two images of FIG. 2, rotated relative to the ribbon;

FIGS. 4A and 4B illustrate bounding areas of an unrotated image and a rotated image, respectively;

FIG. 5 illustrates two images rotated and positioned adjacent one another without a print gap;

FIG. 6 illustrates a print gap between two rotated images, and an enlarged section showing the relationship between the print gap and the print gap in the direction of ribbon movement; and

FIG. 7 illustrates the two images rotated and positioned adjacent one another on the ribbon with a print gap.

### DETAILED DESCRIPTION OF THE DISCLOSURE

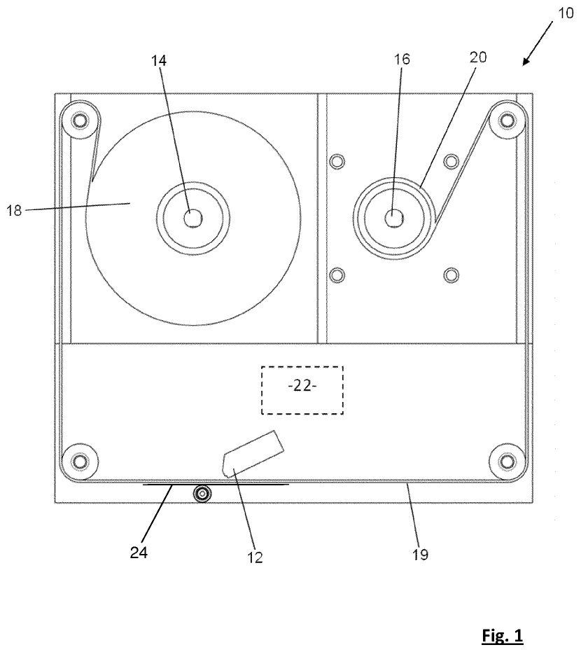

A printing apparatus 10 includes a printhead 12 and a pair of spool supports 14, 16, upon which a spool 18, 20 of ribbon 19 may be mounted. The spool supports 14, 16 are rotatable to transfer ribbon 19 from one spool 18, 20 to the other, past the printhead 12 in a ribbon path. Rotation of the spool supports 14, 16 may be controlled by a controller 22 (shown in dotted lines in FIG. 1, since its position relative to other parts of the printing apparatus 10 is irrelevant). The controller 22 may be operable to control drive signals of one or more motors to enable appropriate rotation of one or both spool supports 14, 16 to accurately transfer and position the ribbon 19.

A substrate 24 is transported past the printhead 12 in a substrate path. The substrate 24 may be any material to be printed, for example a packaging material. Movement of the substrate 24 in the substrate path may be controlled by the controller 22. Movement of the substrate 24 may be monitored by the controller 22, for example as the substrate 24 moves through or near the printing apparatus 10. Movement of the substrate may be monitored by the controller 22 even if movement of the substrate 24 is controlled by an alternative controller, for example a controller that is part of the production line apparatus.

Movement of the printhead 12 relative to the ribbon 19 may be controlled by the controller 22. Movement of the printhead 12 may be substantially parallel to the substrate path and/or the ribbon path. Movement of the printhead 12 may be substantially perpendicular to the substrate path and/or the ribbon path, in other words, towards and away from the ribbon and/or substrate.

Movement of the printhead 12 and/or the ribbon 19 and/or the substrate 24 may be bi-directional.

To carry out a printing operation, the printhead 12 is typically moved towards the ribbon 19 from a ready to print position to a printing position.

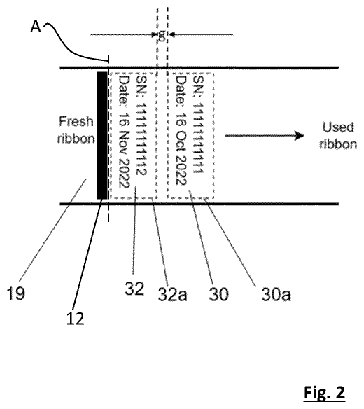

FIG. 2 shows a portion of ribbon 19, after two printing operations have been carried out in typical fashion. A first image 30 is made up of two lines of alphanumeric text in the example shown, but could be any image, such as a barcode, QR code, or a visual image, for example. The first image 30 and the second image 32 depict ink having been removed from the ribbon 19—in other words they are a “negative” image of what has been printed on the substrate 24, and appear in FIG. 2 as if looking “through” the ribbon 19 from the un-inked side. In the example shown in FIG. 2, the images 30, 32 are both printed in a first orientation relative to the printhead. The images 30, 32 are printed “in line” with the printhead 12. The printhead 12 is oriented substantially perpendicular to the direction of travel of the substrate 24 and the ribbon 19. Each image 30, 32 is oriented in FIG. 2 such that an angle θ between the printhead 12 and an axis A which corresponds with the orientation of the first and the second images 30, 32, is approximately 0° and an angle between the direction of travel of the substrate 24 and the image is substantially 90°.

The first image 30 has a first bounding area 30a which is defined by a dotted rectangle in FIG. 2. A second image 32 has a first bounding area 32a, also shown by a dotted rectangle in FIG. 2.

The first bounding area 30a, 32a of each image to be printed 30, 32 is a bounding area that is associated with the respective image 30, 32 when it is in a first orientation relative to the ribbon 19. The bounding areas 30a, 32a are not printable marks, but are used to determine the outer limits of the respective image 30, 32 in each direction.

It is desirable to carry out printing operations close together on the ribbon 19, to avoid wasting ink and ribbon. As can be seen in FIG. 2, the first image 30 and the second image 32 are printed from the ribbon 19 adjacent one another, and are separated by a print gap g. The print gap g is provided to give confidence that an image will not be printed on a portion of ribbon 19 from which ink has already been removed. The print gap g may be of the order of approximately 0.5 mm. The ribbon 19 may be advanced or moved relative to the printhead 12 between printing operations in order to position the ribbon 19 and the printhead 12 ready for the next printing operation to be carried out.

The advance (movement) of the ribbon 19 relative to the printhead 12 to achieve the desired position of successive “images” (i.e. the areas of ribbon from which ink will be removed) on the ribbon 19, is dependent upon the type of printing operation. In intermittent printing operations, for example, the ribbon is advanced relative to the printhead 12, to present a portion of unused (or sufficiently unused) ribbon to the printhead 12, such that the printhead may carry out the next printing operation. In continuous printing operations, for example, the substrate 24 moves substantially continuously past the printhead 12, and the ribbon 19 may be accelerated, decelerated and its direction of travel may be reversed, to achieve correct positioning. It may be necessary or preferable for the ribbon 19 to be rewound between printing operations, such that the next printing operation removes ink from a portion of ribbon 19 which is as close as possible to a portion of ribbon 19 from which ink has already been removed. It is not essential for consecutive printing operations to remove ink from directly adjacent portions of ribbon—it is known to “interlace” images, for example.

The dimensions of the bounding area may be used to derive the print duration and the distance through which the ribbon 19 should be advanced and/or rewound to accurately position the ribbon relative to the printhead 12 and/or the substrate 24. This distance may be achieved by moving the ribbon 19 in either or both directions. It will be appreciated that the ribbon 19 may overshoot the desired position in either or both directions, and the distance to be determined is the aggregate distance to be moved.

In the present invention, each image to be printed may be rotated relative to the ribbon 19. Each image to be rotated may be rotated about its centroid relative to the ribbon 19. Each image may be rotated through an angle θ relative to the ribbon 19. The printhead 12 remains substantially perpendicular to the direction of travel of the substrate 24 and the ribbon 19, and the ribbon 19 remains substantially parallel with the substrate 24.

Components or fields of an image may be rotated relative to other components or fields of the same image and/or relative to the ribbon 19.

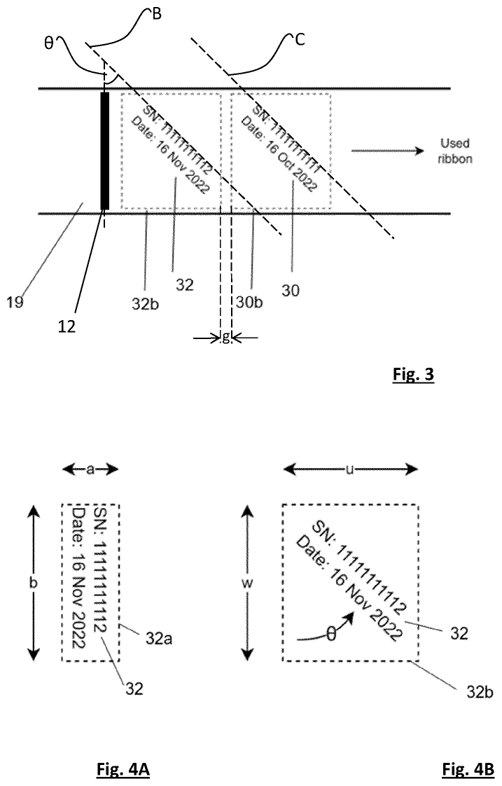

FIG. 3 shows second bounding areas 30b, 32b of the images 30, 32 after each image 30,32 has been rotated through an angle θ relative to the ribbon 19. Each image 30, 32 is shown in FIG. 3 in a second orientation. Each image 30, 32 has a respective axis B, C, which is parallel with the orientation of the corresponding image 30, 32. The axis B, C of each image 30, 32 is rotated through an angle θ relative to the printhead 12. FIG. 4 shows the difference in the first bounding area 32a of the image 32 before rotation, i.e. with the image in the first orientation relative to the ribbon 19 and the second bounding area 32b after rotation, i.e. with the image 32 in a second orientation relative to the ribbon 19. As can be seen, the bounding areas have increased, and this would lead to wasted ribbon and wasted ink if the bounding areas were positioned adjacent one another on the ribbon 19, with a print gap g.

As shown in FIG. 4A, the first bounding area 32a of the image 32 has a length a, and a width b. The width is referred to as such, despite being a smaller dimension than the length in this example, because this dimension is (in the prior art at least) related to the width of the ribbon, the substrate and the printhead. The printhead 12 may be programmed to print an image of any length on to the substrate 24 since the ribbon and substrate are typically provided as long rolls. As shown in FIG. 4B, the second bounding area 32b (associated with the image 32 after rotation, i.e, when the image is in its second orientation relative to the ribbon 19) it has a length u and a width w. The rotation of the rotated image can be expressed as simple trigonometric functions of a and b by the transformations:

$$u = a \times cos ( θ ) + b \times sin ( θ ) \qquad Equation 1$$

$$w = a \times sin ( θ ) + b \times cos ( θ ) \qquad Equation 2$$

The same relationships may be used to determine the second bounding area 30b, 32b of each image 30, 32 to be printed. Whilst only two images are shown, it will be appreciated that a print run may include hundreds or thousands of images.

The angle θ will be known, since this will be a requirement of the print run. This angle is equivalent to the angle through which the entire printing apparatus 10 would have needed to be turned to carry out the printing operation at the required angle on the substrate 24 in a prior art arrangement.

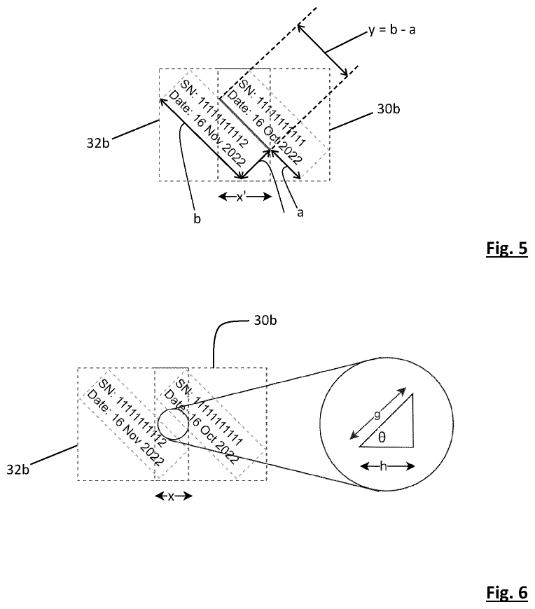

FIGS. 5 to 7 show that in order to reduce wasted ribbon, the ribbon 19 may be advanced between printing operations, such that the images are removed from adjacent portions of ribbon. The controller 22 may use the dimensions a and b of the images to be printed and the rotation angle θ to determine the correct movement of the ribbon 19 relative to the printhead 12 to achieve this positioning.

FIG. 5 shows an example of how the images 30, 32 may be moved closer together on the ribbon 19. In the example shown in FIG. 5, a print gap g is neglected and the bounding areas 30b, 32b overlap one another by a distance x′, which can be calculated as follows.

A distance y is a proportion of the width b of the image 30, 32. The distance y is the proportion of the width b that lies in the overlapping region of the two bounding areas. The distance y may be expressed as follows:

$$y = b - a \qquad Equation 3$$

The length x′ (in the direction of movement of the ribbon) of the overlapping portion of the bounding areas 30b, 32b can be expressed as follows:

$${x}^{′} = ( b - a ) sin θ \qquad Equation 4$$

The distance x′ may be a rewind distance offset.

The bounding areas 30b, 32b may overlap, provided the images 30, 32 do not interfere with one another in such a way that they prevent or inhibit a good quality print being carried out. It may be desirable to maintain a print gap h between adjacent images. The length of print gap h (i.e. the dimension in the direction of travel of the substrate 24 and/or the ribbon 19, i.e. the dimension substantially perpendicular to the printhead 12, may be expressed as follows:

$$h = g cos θ \qquad Equation 5$$

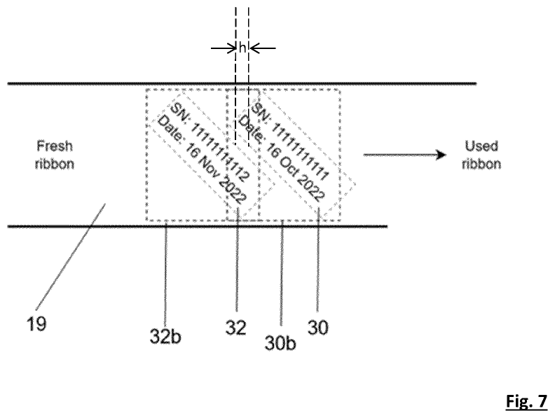

A distance x, is the distance by which the bounding areas of adjacent rotated images overlap, in the direction of travel of the ribbon 19 and/or the substrate 24, when a print gap h is provided. The distance x may be as illustrated in FIG. 6, for example.

The distance x may be determined as follows:

$$x = {x}^{′} - h \qquad Equation 6$$

Thus:

$$x = ( b - a ) sin θ - g cos θ \qquad Equation 7$$

The distance x may be used to determine the distance the ribbon 19 should be advanced between printing operations.

In preparation for printing, the desired image is rendered, meaning it is converted to a pattern of pixels (e.g. a bitmap) which are sent to the printhead 12, and then the elements of the printhead 12 are energised appropriately to create the desired image

The following method of operation of the printing apparatus 10 may be used:
1. Either:
   render the image 30, 32 then rotate rendered image by θ, or
   rotate the image 30, 32 by θ and render;
2. Calculate dimensions u and w from equations 1 and 2 above;
3. Check that w does not exceed the width of the ribbon 19;
4. Prepare the printing apparatus 10 with the following information in advance of the printing operation:
   Image length parallel to ribbon 19 (perpendicular to printhead 12)=u

$$u = a \times cos ( θ ) + b \times sin ( θ ) \qquad ( Equation 1 )$$

$$Rewind distance offset = ( b - a ) sin θ \qquad ( Equation 4 )$$

$$Print gap h = g \times cos ( θ ) \qquad ( Equation 5 )$$

The aspect ratio of each image 30, 32 may be maintained, e.g., at least one of the length a and width b of each image to be printed 30, 32, when the image is in its first orientation and its second orientation.

The controller 22 may be operable to carry out the method described above.

The method above enables wider images to be printed from the same width of ribbon 19. For example, a 45 mm wide image may be made using a 33 mm wide ribbon by rotating the image by 45 degrees since 45×cos(45)≈32 mm.

The printing apparatus and method disclosed herein are further advantageous since the amount of ribbon wasted is kept to a minimum, which has an environmental benefit. Furthermore, wasting less inked ribbon also means it is necessary to change the ribbon less frequently, reducing downtime of production lines, for example.

An image may be printed at a desired angle using the method above, without having to mount the printing apparatus at an angle relative to the substrate path, and/or images wider than the width of the ribbon 19 may be printed onto a substrate in a single printing operation.

Print runs requiring different print angles can be carried out without having to adjust the orientation of the printing apparatus. The required angle of rotation (to achieve the desired second orientation of the image(s) to be printed) can be input, and the second bounding area(s) can be determined, to calculate the rewind distance and the print gap between successive printing operations/images.

Images may be printed at different orientations relative to one another during a print run-different rotation angles θ may be input to enable this. The axes B and C shown in FIG. 3 would not be substantially parallel to one another in this example. This may be useful for interlacing for example (or other ribbon saving techniques), and/or if images need to be printed on the substrate at different orientations—for example a bar code may be printed at a different orientation from a best before date. The method may enable a narrower ribbon to be used than would seem necessary for the widest part of the image.

The method described herein may be used in combination with other ribbon saving techniques, for example radial ribbon saving, where the printhead 12 is moved in a direction substantially perpendicular to the direction of travel of the ribbon 19 and/or the substrate 24, in order to use different portions across the width of the ribbon to carry out successive printing operations.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A method of printing, using a transfer printing apparatus including a ribbon, the method including using a length and a width of a first bounding area of a first image to be printed, the length and the width of the first bounding area being associated with a first orientation of the first image to be printed relative to the ribbon, to determine a length and a width of a second bounding area of the first image to be printed, the second bounding area being associated with a second orientation of the first image to be printed relative to the ribbon of the transfer printing apparatus.

2. A method according to claim 1 including determining a print gap between the second bounding area of the first image and a second bounding area of a second image, each of the first and second images being in its second orientation relative to the ribbon.

3. A method according to claim 1 including determining a distance through which the ribbon is to be advanced between a first printing operation to print the first image in its second orientation, and a second printing operation when the second image is in its second orientation.

4. A method according to claim 1, including one of
a. rendering the first image and then rotating the first image relative to the ribbon into its second orientation; or
b. rotating the first image to be printed relative to the ribbon so that the first image is in its second orientation and then rendering the first image to printed.

5. A method according to claim 1 including printing the first image in its second orientation relative to the ribbon.

6. A method according to claim 1 including printing successive images, each in a respective second orientation relative to the ribbon.

7. A method of printing according to claim 1 including printing an image having a length that is greater than a width of the ribbon.

8. A method of printing according to claim 1 including maintaining an aspect ratio of the first image to be printed between the first orientation of the first image and the second orientation of the first image.

9. A transfer printing apparatus including a printhead and controller configured to control a method of printing, the controller being configured to use a length and a width of a first bounding area of a first image to be printed, the length and the width of the first bounding area being associated with a first orientation of the first image to be printed relative to a ribbon, to determine a length and a width of a second bounding area of the first image to be printed, the second bounding area being associated with a second orientation of the first image to be printed relative to the ribbon of the transfer printing apparatus.

10. A transfer printing apparatus according to claim 9, being a thermal transfer printing apparatus.

11. A transfer printing apparatus according to claim 9 including spool supports, each of the spool supports being arranged to support a spool, and rotatable to transfer ribbon between the spools supported on the spool supports, the controller being configured to control rotation of the spool supports to control movement of the ribbon between the spools.

12. A transfer printing apparatus according to claim 9, wherein the controller is configured to control operation of the printhead to print the first image on a substrate adjacent the printhead.

13. A transfer printing system including a transfer printing apparatus including a printhead and a controller configured to control a method of printing, the controller being configured to use a length and a width of a first bounding area of a first image to be printed, the length and the width of the first bounding area being associated with a first orientation of the first image to be printed relative to a ribbon, to determine a length and a width of a second bounding area of the first image to be printed, the second bounding area being associated with a second orientation of the first image to be printed relative to the ribbon of the transfer printing apparatus, the transfer printing system also including the ribbon, and the transfer printing apparatus being configured to transfer marking medium from the ribbon to a substrate to print the first image.

14. A transfer printing system according to claim 13, wherein the controller is configured to control operation of the printhead to print the first image on the substrate adjacent the printhead, and is further configured to determine a print gap between the first image and a second image on the ribbon, to control the movement of the ribbon to achieve the print gap, and to control operation of the printhead to print the second image by transferring marking medium from the ribbon.

15. A transfer printing system according to claim 13 further including the substrate.

16. A transfer printing system according to claim 15 wherein the controller is configured to control movement of the substrate relative to the ribbon and/or the printhead.
